(19) United States
(12) Patent Application Publication
(10) Pub. No.: US 2016/0275813 A1
(43) Pub. Date: Sep. 22, 2016

(54) NETWORKED COMPUTER COUNSELLING METHOD AND SYSTEM

(71) Applicant: Robert Dovey, Boronia VIC 3155 (AU)

(72) Inventor: Robert Dovey, Boronia VIC 3155 (AU)

(21) Appl. No.: 15/072,436

(22) Filed: Mar. 17, 2016

(30) Foreign Application Priority Data
Mar. 18, 2015 (AU) 2015201442

(51) Int. Cl. G09B 19/00; G09B 5/02

(52) U.S. Cl. CPC G09B 19/00; G09B 5/02

(57) ABSTRACT

A method and system are disclosed for providing counselling services to a student child or adolescent with facilitation by a counsellor aiming to enhance a personal or social skill of the student and using a networked computer system configured to enable communication between the counsellor and student relating to the counselling services, the method comprising a number of steps involved in assigning tasks, awarding experience points and recording and displaying progress on a networked computer system. The networked computer system is further configured to implement the steps of the method.

### CROSS-REFERENCE TO RELATED APPLICATIONS

This application claims priority to Australian application 2015201442, filed 18 Mar. 2015, which is hereby incorporated by reference herein.

### TECHNICAL FIELD

The present invention relates to the provision of professional counselling services, in particular to a method and system for delivering professional counselling services relating to personal and social development.

### BACKGROUND ART

The profession of counselling in a school educational context includes intervention to assist individuals and groups in personal and social competency, which may interact with academic performance but is additional to academic performance. To facilitate the school counselling process, school counsellors use theories and techniques including developmental, cognitive-behavioral, person-centered (Rogerian) listening and influencing skills, systemic, family, multicultural, narrative, and play therapy. Play therapy is typically applied to very young children using for example sandpit toys and involves both undirected observation of play and directed play.

The inventor has perceived a need to find improved ways engage school students, particularly adolescents, in the counselling of personal and social development and problems, and has conceived of the application of an idea which until now has been applied only outside of the profession of counselling.

This is called gamification, for which there has been an increasing use in a number of areas, including to assist students of a wide range of ages in learning academic skills. In gamification of learning, elements which make video games fun are introduced into the learning process. For example, the language and structure of video games such as “quests”, “experience points”, and special “powers” overlay the educational goals in a particular subject such as mathematics, in contrast to traditional instruction, exercises, and marked tests. Video games inherently provide a level of autonomy and empowerment to the player who progresses through the learning experience at their own pace and also provide a level of safety where the player is able to experience episodes of failure requiring only repetition until success is achieved, without long-term consequence such as may be experienced by an adverse irrevocable test score in a traditional coursework assessment context. Also, children and adolescents are attuned to the fun component of video game language which can be exploited to enhance enjoyment in an educational setting.

Gamification of learning, then, may be defined as the process of implementing video game concepts in a non-play, non-gaming learning context. The inventor has conceived application of the context outside of academic skills to a counselling situation. Counselling is a service provided in most schools by professional practitioners, but does not usually make use of academic educational techniques in its delivery. It is believed that particularly in respect of the empowerment experienced during a video game, extending the video game analogy to enhancement of real-world personal and social skills in the counselling profession is particularly promising.

### SUMMARY OF INVENTION

In accordance with a first broad aspect of the invention there is provided a method of providing counselling services to a student child or adolescent with facilitation by a counsellor aiming to enhance a personal or social skill of the student and using a networked computer system specially adapted to enable communication between the counsellor and student relating to the counselling services, the method comprising the steps of:
ensuring that the student is enrolled as a user of the computer system;
assigning to the student a program of real life tasks relating to the enhancement aim with associated experience points to be awarded on achievement thereof;
recording the real life tasks and a progress of achievement thereof in the computer system so as to be viewable by the student through the computer system;
awarding and accumulating experience points to the student on the achievement of one or more of the assigned real life tasks;
recording at least the accumulated number of experience points in the computer system so as to be viewable by the student through the computer system;
awarding one or more real life rewards to the student, each real life reward conferring a real life benefit on the student; and
recording the one or more real life rewards in the computer system so as to be viewable by the student through the computer system.

In one embodiment, at least one of the real life rewards is a power conferring a real life privilege on the student exercisable by the student on demand.

In one embodiment, at least one of the real life rewards is awarded after achievement of at least a milestone aggregate number of the experience points.

In one embodiment, the method further comprises the steps of:
assigning an experience level to the student reflecting progression in the enhancement of the skill; and
recording the experience level in the computer system so as to be viewable by the student through the computer system. The progression may be determined according to the aggregate number of experience points. The awarding of one or more real life rewards may coincide with the student reaching one or more of the experience levels.

In one embodiment, the real life benefit conferred by at least one of the real life rewards comprises a rewind privilege to avoid a disciplinary action in relation to a behavioral transgression committed by the student, wherein the student under facilitation from the counsellor opts to re-enact circumstances of the transgression and choose in the re-enactment a more acceptable behavior.

In one embodiment, the real life benefit conferred by at least one of the real life rewards comprises an invisibility privilege to avoid a situation that makes the student anxious or uncomfortable. The invisibility privilege may not be available to avoid an academic assessment situation.

In one embodiment, the real life benefit conferred by at least one of the real life rewards comprises a pause privilege to provide a time period during which the student and a teacher will not speak to each other.

In one embodiment, exercise of at least one of the privileges by the student initiates a cool down period during which the privilege is unavailable to be further exercised.

In one embodiment, the tasks include a set of short generic tasks able to be completed in a few minutes.

In one embodiment, the tasks include a set of personal tasks unique to the student.

In one embodiment, the tasks include a set of joint tasks to be undertaken by groups of students cooperatively.

In accordance with a second broad aspect of the invention there is provided computer-based system for providing counselling services to a student, child or adolescent with facilitation by a counsellor aiming to enhance a personal or social skill of the student, the computer-based system being a networked computer environment specially adapted to enable communication between the counsellor and student relating to the counselling services, and providing a username membership structure to enable the student to be enrolled as a user of the computer system and to enable the student have access to a notification facility; the networked computer environment comprising:
a data recording component specially adapted to record real life tasks assigned to student relating to the enhancement aim, progress of achievement of the real life tasks, an accumulated number of experience points awarded on achievement of one or more of the assigned real life tasks, and one or more real life rewards awarded to the student, each real life reward conferring a real life benefit on the student; and
a display component specially adapted to display through the notification facility information concerning the real life tasks assigned to the student, the progress of achievement of the real life tasks, the accumulated number of experience points, and the one or more real life rewards awarded to the student.

In one embodiment, at least one of the real life rewards is awarded after achievement of at least a milestone aggregate number of the experience points, and the display component is specially adapted to display the milestone aggregate number as a target for the student.

In one embodiment, the data recording component is further specially adapted to record an experience level assigned to the student reflecting progression in the enhancement of the skill; and the display component is further specially adapted to display the experience level of the student.

In one embodiment, exercise of at least one of the real life rewards by the student initiates a cool down period during which the real life reward is unavailable to be further exercised;
the data recording component is further specially adapted to record whether the real life reward is in the cool down period and unavailable to be further exercised, and
the display component is further specially adapted to display whether the real life reward is the cool down period and unavailable to be further exercised.

In one embodiment, the notification facility comprises at least elements which are private notifications to the student exclusive of other student users.

In one embodiment, the notification facility comprises at least elements which notify collectively to groups of students participating in one of the tasks which is a joint task to be undertaken by the group of students.

In one embodiment, the username membership structure includes a specially adapted aggregate user the experience points of which represent an aggregate of the experience points of all student users of the system, and the display component is specially adapted to display to all student users of the system the progress of the aggregate user so as to provide a community goal for all student users.

### BRIEF DESCRIPTION OF DRAWINGS

FIG. 1 is a block diagram of a networked computer system according to an embodiment of the 2nd broad aspect of the invention;

FIG. 2 is a block diagram of the methods steps of an embodiment of the first broad aspect of the invention;

FIGS. 3 and 4 are screenshots of pages of an embodiment of the display component of the networked computer environment according to the invention.

### DESCRIPTION OF EMBODIMENTS

An embodiment in relation to both aspects of the current invention will now be described. The embodiment relates to students in a school, and is a tool used by the counsellors to assist students in need with personal and social development.

In addition to the components of the system described below, a room in the school set aside as a counselling space where the students in need of emotional safety, personal space or advice can spend time if needed or if required according to the system of the invention.

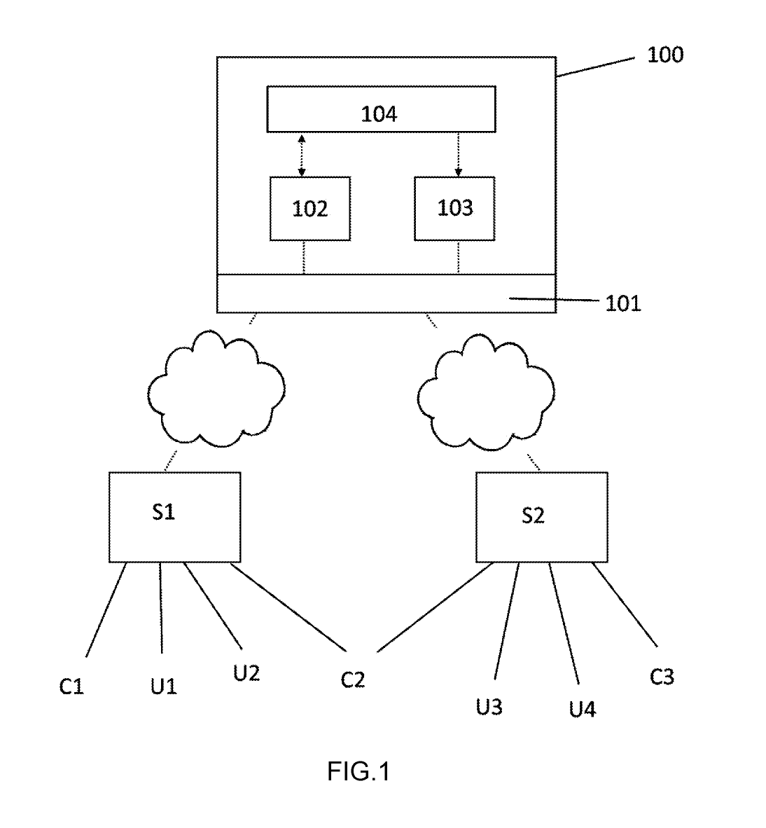

Referring first to FIG. 1, the networked computer system comprises a web-connected server 100 accessible via a website interface 101 interacting with recording component 102 and display component 103 of the system, typically implemented in software, connected to database 104 comprising a physical memory, being a non-transitory computer readable medium, located either locally with the server or remotely. A number of schools S1, S2 have login access to website interface 101, in each school a number of counsellors C1, C2, C3 and student users U1-U4 having login access. Counsellors C1, C2, C3 some of which may be associated with more than one school typically have administration privileges allowing access to both recording component 102 and display component 103. Student users U1-U4 typically have only access to display component 103 which may however include social media bulletin boards etc. to which they can contribute content. Display component 103 comprises a web interface where the student interacts via a student profile page which contains information as described below which may be private to the student, forming a partly private notification facility.

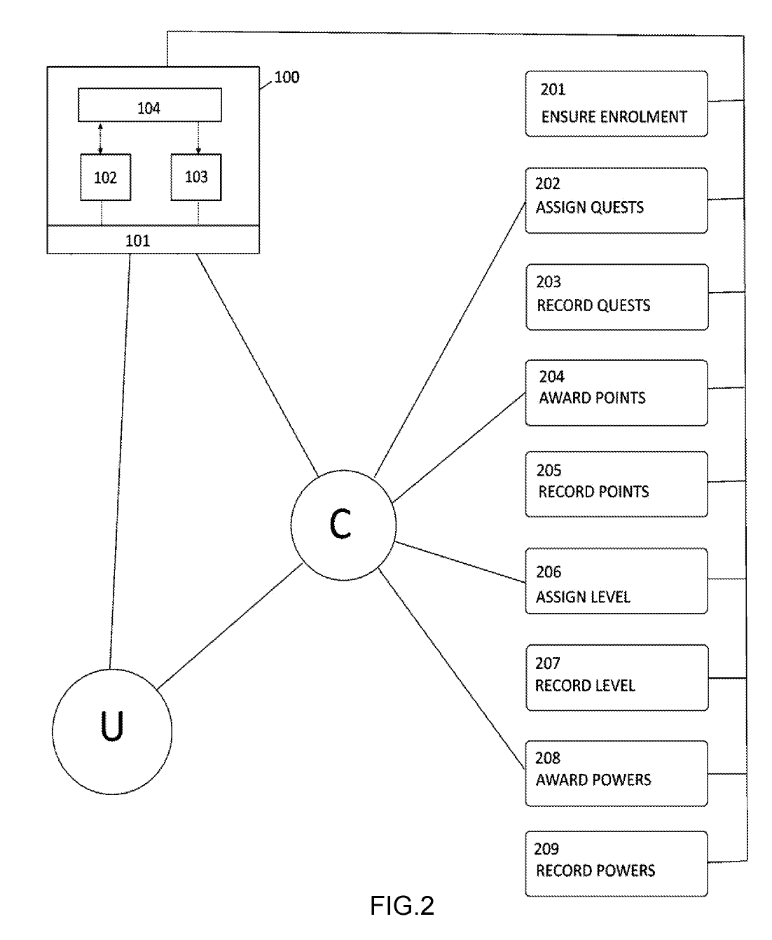

Referring now also to FIG. 2, key steps of the method aspect of the invention are set out together with connecting lines indicating agency. Student user U performs actions in the real world and interacts with counsellor C and is able to access the student profile and progress via display component 103 of web connected server 100 through website interface 101. Counsellor C has interacts with computer system 100 to a varying extent in respect of most or all of the method steps, and particularly in relation to a few of the methods steps performs these in part directly, such as by decision-making and negotiation with student user U in relation to step of awarding experience points, to be described below.

The first step 201 is to ensure that the student needing to enhance a person or social skill is enrolled as a user of the networked computer system shown in detail in FIG. 2. If the student is not already enrolled, typically the counsellor logs into an administration username and as the students details into the system, which include the students full name, the students first name and an alias to which they wish to be referred in the system if they choose. Student details may also include an image which may be used as an avatar to enhance the invocation of gaming concepts. Additional details may include an institution identifier for systems which extend across a number of schools.

The next step, assignment step 202, is to assign to the student a program of real-life tasks relating to the enhancement aim with associated experience points to be awarded on achievement thereof. The real-life tasks are advantageously called “quests” to enhance the invocation of gaming concepts and will hereinafter be referred to as such. The performance of this step may involve an element of automatic assignment by the computer system in relation to generic quests which are able to be completed by the student in a few minutes and which have broad application, such as “meet and talk to someone new”, or “help someone in need”. Typically, the performance of the quest assignment step 202 also involves the assignment of typically unique personal quests for the student which may be devised by the counsellor in consultation with the student and entered into the system by the counsellor. The assignment step 202 may also involve the assignment of group tasks called “epic quests” which can be undertaken by groups of students, typically 2 to 5 in number. The counsellor also decides an associated number of experience points to be awarded when the student achieves each quest. Allied with the assignment step 202 is a recording step 203 wherein the quests are entered into the computer system by the counsellor so as to the viewable by the student on a student profile page when logged into the system. On entry of the quests, which may be selected in part from a pulldown list of generic quests or typed in as free-form text particularly for personal or epic quests, the counsellor also enters the number of experience points to be associated. In the case of pre-loaded generic quests, the system may provide predetermined suggestions as to the number of experience points which have been balanced from past experience in order to ensure that students are appropriately rewarded, or may record the experience points for the generic quests automatically. In the case of personal quests or other unique quests, the counsellor makes an educated decision as to the appropriate number of experience points to be awarded, while understanding that awarding too many points overvalues the quest and awarding too few under-motivates the student.

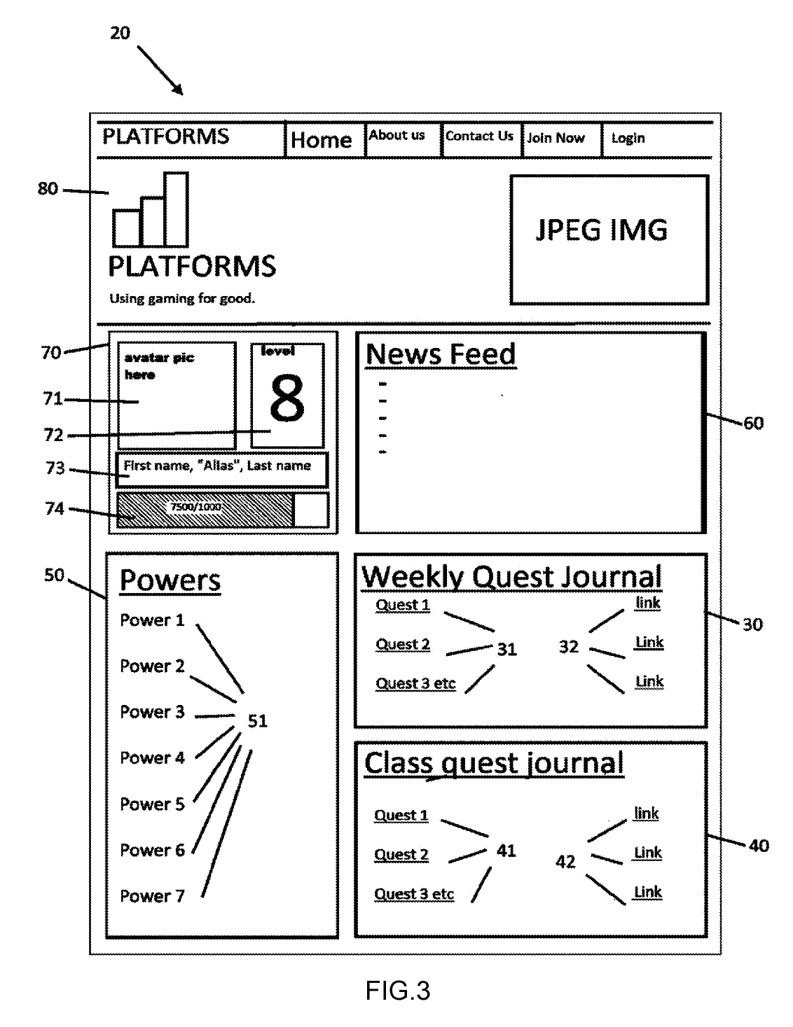

Once recorded, the networked computer system is designed such that details of quests and associated experience points to be awarded may be viewed by the student through a display component comprising a number of pages or screen layouts displayed on an interactive computer display. FIG. 3 shows a student profile page 20 of the display component which displays a number of windows. The text provided in FIG. 3 is generic and is intended to describe the nature of the content to be displayed as described below. A weekly quest journal window 30 lists brief, preferably descriptive, identifiers 31 of active personal quests assigned to the student. A class quest journal window 40 lists brief, preferably descriptive, identifiers 41 of epic quests assigned to a group (in this case a school class).

Hyperlinks 32 and 42 provide access to a quest view and edit page to be described below. Power window 50 lists brief, preferably descriptive, identifiers 51 of the real life rewards in the form of powers described below currently possessed by the student. A summary window 70 comprises an avatar or other pictorial identifier for the student 71, and experience level 72 described below, the name or alias for the student 73 and an experience points progress display 74 displaying the number of accumulated experience points e.g. “7500” and the further amount e.g. “1000” required to be accumulated until an experience level is increased as described below in step 206. News window 60 provides general news to the enrolled community, and banner area 80 provides a common header identifying the system, common to a plurality of pages.

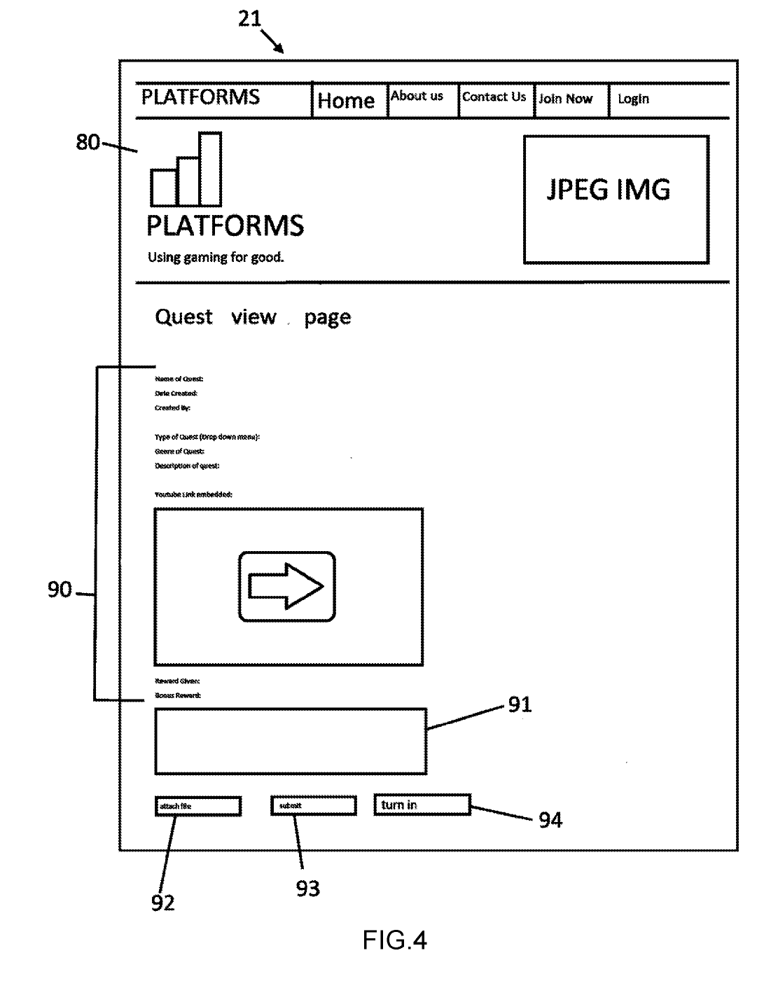

A step 204 begins when a student considers that one of the quests is achieved. The student accesses a quest view/edit page through the appropriate hyperlink 32 (or 42) shown in FIG. 3. Display of the quest view/edit page 21 is shown in FIG. 4. Entries collectively identified as 90 provide information about the quest as indicated, including a YouTube link or similar for a detailed explanatory video, and also including the reward to be given and any bonus reward. Typically, the reward is a number of experience points and the bonus reward may include more experience points or one of the real life rewards mentioned below, which may be awarded at the discretion of the counsellor or automatically. A text entry window 91 provides a place for the student to provide an account of progress or attainment of the quest. File attachment button 92 provides a facility to upload supporting documents, and submit button 93 causes the communication to be effected through database 104. If the student is wishing to claim completion of the quest, the student also presses quest turn in button 94. Pressing the quest turn-in button 94 requires the student to complete a brief survey to ensure validity. The counsellor then follows up later and may discuss with the student how the quest has allegedly been achieved, and decides whether or not to agree and award the experience points. Following agreement, the counsellor logs in with administrator privileges and marks the quest as achieved in the student profile, in response to which the system adds the awarded experience points to the accumulated experience points 33 of the student displayed on the student profile page and applies any bonus rewards if appropriate. The quest then typically disappears from the list of open quests, and in step 205 the accumulated number of experience points are recorded so as to the viewable by student through the computer system in experience points progress display 74.

More generally the communication between student and counsellor, including communication from the student regarding alleged completion of a quest, may be via a communications subsystem of the network as described above or by other social media or person-to-person communications.

This embodiment incorporates in step 206 the concept of assigning an experience level, further invoking gaming concepts. The student begins in this embodiment at experience level 1 and the experience level is automatically incremented on achievement of predetermined numbers of experience points, which may be adjustable. In this embodiment steps 206 of the assigning the experience level, and step 207 of recording the experience level in the computer system so as to be viewable by the student through computer system, are automatic. The experience level is seen in window 39 of the student profile page.

In step 208 and 209, the student is awarded one or more real life rewards in the form of powers which are recorded in the computer system so to be viewable by the student on the student profile page in a power window 50. As discussed above, the real life rewards may in various implementations and circumstances be awarded on achievement of a prearranged number of experience points, a prearranged experience level, as a prearranged bonus reward on completion of a particular request or at the discretion of counsellor. Each power confers a real-life privilege on the student exercisable by the student on demand. More generally, the rewards may be any real life benefit and can include material rewards, although “powers” are generally preferred. In this embodiment, there are 3 major generic powers which are generally able to be awarded, but the system is configured to allow any number of uniquely designed powers for the needs of particular student. The counsellor may award and record the powers manually, or for some powers—particularly the generic powers—the system automatically awards and records a power after achievement of at least a milestone aggregate number of the experience points, achievement of a particular experience level, or as predefined as a bonus reward on achievement of a particular quest.

The real-life privileges associated with the powers typically relate to ordinary activities that are already in principle available to students in the school, except formalized in terms of the circumstance in which the student has a right to action them and reframed in the video game language. The 3 generic powers in this embodiment are described below.

Rewind power. The rewind power is, in its broadest form, a privilege to re-enact a situation in which the student experience the difficulty. For example, it may be used to avoid disciplinary action in relation to a behavioral transgression committed by the student, awarded in this embodiment at experience level 3. Instead, the student opts to re-enact circumstances of the transgression and discovering a more acceptable behavior through the re-enactment. The student can revisit a period of time from the last 48 hours and re-enact the events. For example, if a student is unable to regulate his or her emotions in the classroom and has an outburst towards a teacher, they could be facing disciplinary action from the school. This would only add to the anxiety of the student, nor would they learn anything about their behavior. By exercising the rewind power, the student speaks to a counsellor and the counsellor facilitates the power to be used. The teacher is brought into what is essentially a mediation where the student and teacher “replay” the scenario and the student instead chooses the behavior that they would have preferred had they been in a more peaceful emotional state. Typically, counsellor can mediate with the other parties so that the previous “attempt” at the event is not referenced effectively rendering the bad behavior “stricken from the record”, and could not be used in the rewind exercise to shame the student. The rewind power in this embodiment may be exercised at any time, with the limitation that the exercising of the rewind power is associated a cool down period during which the power is unavailable to be further exercised, to avoid abuse of the power. An appropriate cool down period for the rewind power has been found to be 3 days. Another example of use of the rewind power include a privilege to take back something hurtful the student said, perhaps to another student.

Invisibility power. The invisibility power is a privilege to avoid a situation that makes a student anxious or uncomfortable. Students who have this power in this embodiment are given a card which, when they wish to action the invisibility power, they hold up and show the teacher which enables them to withdraw or avoid the situation. The aim is to give the students who need it a non-verbal cue to allow them to escape. In this embodiment, the power is used at the student's discretion but is unavailable to be exercised in an academic assessment such as a test, SAC or exam. Also, the student is required to go to the counselling space during the period of the avoidance to make use of the time, although the use is not specified. A cool down period associated with this power may be appropriate.

Pause power. The pause power is a privilege to provide a time period during which the student and a teacher will not speak to each other. This power essentially empowers the student to remove themselves from a situation where the student may be unable to regulate their emotions. By students learning to recognize their situational triggers and actioning this power, incidents that are often seen where a student emotionally explodes in class and disrupts the class can be mostly prevented.

In addition to the student users, a further user of the system in this embodiment is a virtual aggregate user called “the Well Of Light” the experience points of which are derived as an aggregate of the experience points of all student users of the system, typically only in relation to the generic quests which are likely to be shared by all students. Inclusion of the Well of Light as a user provides a community goal for student users who can experience the collective enhancement of skills in the student population.

Case Studies

Case study 1. One use of the system is to help assist in dealing with school refusal. Students who suffer school refusal don't find school inherently rewarding, caused by a combination of mental health problems and the school system which doesn't provide consistent or tangible rewards for work achieved to these student. In use of a prototype version of the system, a student had failed to attend school for a period of 2 weeks, and it was revealed that he was disinterested and anxious about the school environment and having difficulties with another student, with friends and with a teacher. He was enrolled in the system and since then has not missed any dates of school. He has been observed to be checking through computer system on his progress daily and engaging with the counselling process and has recently asked if two friends can also enroll in the system.

Case study 2. This student has been diagnosed with ADHD, autism and anxiety. As she used the system she quickly began finding ways to exploit the game and find shortcuts in an effort to “win”. It was explained to her that certain attempts to exploit the game were not in the spirit, and she became extremely anxious. Counsellor reinforced the rules and expectations of the game and she became much more receptive. She is now at the highest experience level and active contributor. It is believed that the fact that the game has rules, boundaries and expectations while giving students agency and responsibilities is important in such an example.

Case study 3. This is an example of the use of the quest “talk to someone new”. This student has attempted suicide on multiple occasions. He struggles at school and often sits on its own listening to music he has had a tragic circumstances with his parents and seems to find everyday email it to climb. Both he and another girl in the study has spent a large amount of time in the counselling space, sitting separately and never talking. Then on the week of the “talk to someone new” quest, they spoke together the first time in our support each other and now hang out regularly.

Benefits

The invention makes synergistic use of the organizing power of computers and the familiarity and attractiveness of the video or computer game paradigm in the context of counselling and mental health. The invention amounts to substantially more than applying existing counselling techniques to a computer environment. The invention exploits a hitherto unexplored psychological synergy between counselling goals and video or computer game concepts by utilizing the computer environment and in its broadest aspect the video game concepts of tasks (“quests”) and experience points.

Benefits of embodiments of invention include the following:
Agency—if the student can choose when to action powers, they can use to control the events in their life.
Narrative—the use of the powers, quests and other structures gives the students a reference point of their behavior and enables them to reference “that time they used rewind” to develop a sense of progression in their wellness
Language—the system in invoking well understood video game concepts of quests, powers and levels gives students a language—i.e. it gives the students words where they would otherwise struggle to find them.
Failure states—this is a concept in videogame design where a player reaches a point where success is no longer possible without restarting from previous point. An example in a video game would be Mario falling down a hole and losing a life. Mario needs to restart from previous point to reattempt the obstacle. Comparing the failure state of Mario in videogame to a similar situation in real life reveals that most video games remove or lessen the severity of the failure state compared to real life. This is understood by children familiar with video games who are used to succeeding after multiple failure states. With the invention, if a student loses control in a real-life situation, they are able to reattempt the situation by using a power without as much fear of failing.

Persons skilled in the art will also appreciate that many variations may be made to the invention without departing from the scope of the invention, which is determined from the broadest scope and claims.

For example, the experience points may be expressed in any number of forms, and may be represented as simply an abstract numerical score or amounts of a virtual currency, or numbers of collectable symbols or objects. Also, the real life rewards may include any reward that relates to real life value, not necessarily in the student environment. For example, a real life reward may consist of entertainment such as concert tickets, money, or the ability to convert experience points into money.

Further, it will be appreciated that the networked computer system and environment including the data recording component of the display component are typically implemented by special purpose applications to the running on existing web-based hardware and software as is well known in the art, but may be implemented by a number of alternative architectures. It is the functionality of the computer-based system as defined in the claims which is central to the invention rather than any particular physical form.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention. Further, any method steps recited in the claims are not necessarily intended to be performed temporally in the sequence written, or to be performed without pause once started, unless the context requires it.

It is to be understood that, if any prior art publication is referred to herein, such reference does not constitute an admission that the publication forms a part of the common general knowledge in the art, in Australia or any other country.

What is claimed is:

1. A method of providing counselling services to a student child or adolescent with facilitation by a counsellor aiming to enhance a personal or social skill of the student and using a networked computer system specially adapted to enable communication between the counsellor and student relating to the counselling services, the method comprising the steps of:
ensuring that the student is enrolled as a user of the computer system;
assigning to the student a program of real life tasks relating to the enhancement aim with associated experience points to be awarded on achievement thereof;
recording the real life tasks and a progress of achievement thereof in the computer system so as to be viewable by the student through the computer system;
awarding and accumulating experience points to the student on the achievement of one or more of the assigned real life tasks;
recording at least the accumulated number of experience points in the computer system so as to be viewable by the student through the computer system;
awarding one or more real life rewards to the student, each real life reward conferring a real life benefit on the student; and
recording the one or more real life rewards in the computer system so as to be viewable by the student through the computer system.

2. The method of providing counselling services of claim 1, wherein at least one of the real life rewards is a power conferring a real life privilege on the student exercisable by the student on demand.

3. The method of providing counselling services of claim 1, wherein at least one of the real life rewards is awarded after achievement of at least a milestone aggregate number of the experience points.

4. The method of providing counselling services of claim 1, further including the steps of:
assigning an experience level to the student reflecting progression in the enhancement of the skill; and
recording the experience level in the computer system so as to be viewable by the student through the computer system.

5. The method of providing counselling services of claim 3 wherein the progression is determined according to the aggregate number of experience points.

6. The method of providing counselling services of claim 5, wherein the awarding of one or more real life rewards coincides with the student reaching one or more of the experience levels.

7. The method of claim 1, wherein the real life benefit conferred by at least one of the real life rewards comprises a rewind privilege to avoid a disciplinary action in relation to a behavioral transgression committed by the student, wherein the student under facilitation from the counsellor opts to re-enact circumstances of the transgression and choose in the re-enactment a more acceptable behavior.

8. The method of claim 1, wherein the real life benefit conferred by at least one of the real life rewards comprises an invisibility privilege to avoid a situation that makes the student anxious or uncomfortable.

9. The method of claim 8 wherein the invisibility privilege is not available to avoid an academic assessment situation.

10. The method of claim 1, wherein the real life benefit conferred by at least one of the real life rewards comprises a pause privilege to provide a time period during which the student and a teacher will not speak to each other.

11. The method of claim 2, wherein actioning of at least one of the privileges by the student initiates a cooldown period during which the privilege is unavailable to be further exercised.

12. The method of claim 1, wherein the tasks include a set of short generic tasks able to be completed in a few minutes.

13. The method of claim 1, wherein the tasks include a set of personal tasks unique to the student.

14. The method of claim 1, wherein the tasks include a set of joint tasks to be undertaken by groups of students cooperatively.

15. A computer-based system for providing counselling services to a student child or adolescent with facilitation by a counsellor aiming to enhance a personal or social skill of the student, the computer-based system being a networked computer environment specially adapted to enable communication between the counsellor and student relating to the counselling services, and providing a username membership structure to enable the student to be enrolled as a user of the computer system and to enable the student have access to a notification facility; the networked computer environment comprising:
a data recording component specially adapted to record real life tasks assigned to student relating to the enhancement aim, progress of achievement of the real life tasks, an accumulated number of experience points awarded on achievement of one or more of the assigned real life tasks, and one or more real life rewards awarded to the student each real life reward conferring a real life benefit on the student; and
a display component specially adapted to display through the notification facility information concerning the real life tasks assigned to the student, the progress of achievement of the real life tasks, the accumulated number of experience points, and the one or more real life rewards awarded to the student.

16. The computer-based system of claim 15 wherein at least one of the real life rewards is a power conferring a real life privilege on the student exercisable by the student on demand.

17. The computer-based system of claim 14 wherein at least one of the real life rewards is awarded after achievement of at least a milestone aggregate number of the experience points, and the display component is specially adapted to display the milestone aggregate number as a target for the student.

18. The computer-based system of claim 14 wherein the data recording component is further specially adapted to record an experience level assigned to the student reflecting progression in the enhancement of the skill; and the display component is further specially adapted to display the experience level of the student.

19. The computer-based system of claim 16, wherein exercise of at least one of the privileges by the student initiates a cool down period during which the privilege is unavailable to be further exercised;
the data recording component is further specially adapted to record whether the privilege is in the cool down period and unavailable to be further exercised, and
the display component is further specially adapted to display whether the privilege is the cool down period and unavailable to be further exercised.

20. The computer-based system of claim 15, wherein the notification facility comprises at least elements which are private notifications to the student exclusive of other student users.
